(19) United States
(12) Patent Application Publication
(10) Pub. No.: US 2007/0106694 A1
(43) Pub. Date: May 10, 2007

(54) STRUCTURALIZED DOCUMENT, CONTENTS DELIVERY SERVER APPARATUS, AND CONTENTS DELIVERY SYSTEM

(76) Inventors: Masami MORI, Tokyo (JP); Akira Suzuki, Kanagawa (JP); Takefumi Hasegawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/550,214

(22) Filed: Oct. 17, 2006

(30) Foreign Application Priority Data
Oct. 31, 2005 (JP) 2005-316897

(51) Int. Cl. G06F 17/00

(52) U.S. Cl. 707/104.1

(57) ABSTRACT

A structuralized document is provided that includes a contents part and a program part. The programs part stores a computer-readable program which, when executed by a computer, causes the computer to perform a process including the steps of accessing a contents delivery server apparatus, inputting contents provided at the contents delivery server apparatus as an external resource, restructuring the input external resource into a document file, and storing the restructured document file in the contents part.

### BACKGROUND OF THE INVENTION

1. Field of the Invention

The present invention relates to a structuralized document that is suitably used for distributing or receiving contents such as web magazines and mail magazines, a contents delivery server apparatus, and a contents delivery system. Specifically, the present invention relates to a technique for improving usability (e.g., storing) of distributed contents such as web magazines and mail magazines through use of a structuralized document that integrates programs and contents.

2. Description of the Related Art

It is noted that Japanese Laid-Open Patent Publication No. 2004-310378 discloses a technique for automatically sorting information obtained through web crawling according to contents.

Also, Japanese Laid-Open Patent Publication No. 2003-15941 discloses a structuralized document (encapsulated document) having a program attached thereto.

[Website Archiving]

It is noted that various types of information are provided over the Internet, and a user may obtain latest information pertaining to a particular subject by bookmarking a website providing information that is of interest to the user, or using RSS (Rich Site Summary) feeds, for example. However, a large share of information on the Internet is provided by individuals for non-commercial purposes, and websites managed by such individuals may be closed all of a sudden without nay warning or contents of such websites may be suddenly altered, for example.

Also, the probability of a previously bookmarked link still being valid is relatively low, and the average service life of a URL (uniform resource locator) is estimated to be around 44 days according to some sources. Further, information provided by certain web sites such as news sites may be constantly updated, and since contents are not bound together as in a book, newspaper, or a magazine, it may not be possible to confirm what was posted at a certain point in time such as “15:00 of the previous day” unless the contents have been recorded at that point in time.

In view of such circumstances, services such as web archive (http://www.archive.org/) have been developed. Such service attempts to preserve information with a short life span that is soon erased.

However, from the perspective of a user, archiving the entire contents provided over the Internet may be unnecessary. Specifically, considering the limited storage capacity of a hard disk, a user may only wish to have certain site information archived that is of interest to the user. Current measures for archiving site information include the user storing the site information himself/herself, or employing software that periodically gathers data. It is noted that software designed to periodically gather data has certain drawbacks with regard to its data storing method. That is, such software merely stores data in a designated file in an arbitrary manner.

As is disclosed in Japanese Laid-Open Patent Publication No. 2004-310378, for example, tools (e.g., freeware or shareware) are disclosed over the Internet for gathering information through web crawling. However, such tools have drawbacks in that although they are capable of gathering information, the information such as website information is gathered according to its folder structure (e.g., every web page of a site is saved in a new folder) and the information is stored in an arbitrary manner so that it may be rather difficult to handle. For example, since the information is not saved as one bundle, problems may arise with respect to compiling the information when information of plural sites is gathered, for example.

[Archiving Data on LAN]

A local area network (LAN) is generally constructed within a business office where files are shared by a number of file servers, for example. In such an environment, a file may be added to information or the layers of folders of the corresponding information may be increased arbitrarily so that browsing may be troublesome, for example. Also, a web server may be provided over a LAN where information is updated on a daily basis, for example. In such a case, it is impossible to determine the information previously posted on the web server at a certain point in time, for example.

[Archiving Mail Magazines]

There are users that subscribe to mail magazines to obtain desired information. Mail magazines may be convenient in that they periodically provide pertinent information to a user without requiring the user to input a URL and actively access the site providing such information.

However, the when a user subscribes to plural mail magazine services, the mail box of the user may be filled with unread mail. It is noted that oftentimes, mail magazines incorporate their contents into advertisement information so that a user may have difficulty sifting through desired or relevant information when reading a number of the mail magazine transmissions at once, for example. Also, it is noted that in many cases, back numbers of mail magazines are disclosed on websites as archives. However, in this case, a link to each entry may be separately provided so that it may be troublesome to read a number of the entries at once.

Mail archiving software for storing and managing mail are generally known. Also, Lotus Notes (registered trademark) is equipped with a mail archiving function, for example. Such mail archiving software/function is configured to store and backup received mail. A drawback to such mail archiving software/function is that although mail transmissions are generally in a standard format such as text format or HTML (Hyper Test Markup Language) format, the mail archiving software/function only enables viewing of the archives through a mailer.

[Archiving in Synch with Other Documents]

In recent years and continuing, there has been much improvement in technology related to collaboration under a remote environment through sharing documents at a television conference, for example. Currently used methods for sharing documents include the following:
(1) synchronizing folders;
(2) using a shared folder;
(3) imaging documents and sharing the images;
(4) imaging documents at one location and transmitting the images to another location;
(5) synchronizing document display in a predetermined format

However, there are drawbacks to the methods of sharing documents listed above. Specifically, in the case of using the methods (1) and (2), folders are shared rather than documents so that inconveniences may be created with regard to establishing communication. Also, in the case of using method (3), since the documents are converted into images, display characteristics may be degraded when the documents are enlarged owing to typical image-related problems, for example.

In a case where method (4) is used, although operations may be performed on the document at the location at which the document is stored, such operations may not be performed at the location that merely receives an image of the document so that desirable communication may not be established. In a case where the method (5) is used, since document formats that are equipped with display synchronization capabilities are relatively limited, imaging has to be performed on documents in other formats to synchronize document display.

It is noted that in response to the problems related to document sharing and synchronization, a technique has been proposed for synchronizing documents by having plural locations hold the same document and enabling information exchange between the documents. Method (5) as is described above is an example of such a technique. By employing such a technique, operations may be performed on a document from any location without being restricted by a master-servant relationship between the documents as in the case of method (4) so that desirable communication may be established, for example. However, even when such a technique is used, other resources cannot be added during communication and searched results cannot be synchronized, for example.

### SUMMARY OF THE INVENTION

In one aspect of the present invention, a document generating technique is provided for inputting external data such as data provided over the web or a LAN, packaging the input external data, converting the data into document data, and enabling synchronization of the document data with external data so that data recording and collaboration may be facilitated.

According to an embodiment of the present invention, a structuralized document is provided that includes:

a contents part that stores contents; and

a program part that stores a computer-readable program which, when executed by a computer, causes the computer to perform a process including the steps of accessing a contents delivery server apparatus, inputting contents provided at the contents delivery server apparatus as an external resource, restructuring the input external resource into a document file, and storing the restructured document file in the contents part.

In one preferred embodiment of the present invention, the input external resource may be electronic mail contents or contents of a designated Uniform Resource Locator.

In another preferred embodiment of the present invention, the process may include a step of generating a fee charge when the external resource is input.

In another preferred embodiment of the present invention, the process may include a step of synchronizing the restructured document file with an external document.

In another preferred embodiment of the present invention, an identification code may be assigned to the program included in the program part, and a number of times the external resource is input may be controlled by the identification code.

In another preferred embodiment of the present invention, update information may be included in the external resource, and the step of inputting the external resource is performed when the external resource is determined to be updated based on the update information.

According to another embodiment of the present invention, a contents delivery server apparatus is provided that includes:

a storage part the stores a structuralized document that is configured to input an external resource, restructure the input external resource into a document file, and store the restructured document file;

a structuralized document transmitting part that transmits the structuralized document in response to document access made by a terminal apparatus; and

an external resource transmitting part that transmits the external resource in response to contents access made by the terminal apparatus.

According to another embodiment of the present invention, a contents delivery system is provided that includes:

a contents delivery server apparatus storing a structuralized document configured to input an external resource, restructure the input external resource into a document file, and store the restructured document file;

a terminal apparatus that is connected to the contents delivery apparatus via an information network;

a structuralized document transmitting part that is included in the contents delivery server apparatus, and is configured to transmit the stored structuralized document to the terminal apparatus in response to document access made by the terminal apparatus; and

an external resource transmitting part configured to transmit the external resource in response to contents access made by the terminal apparatus.

### BRIEF DESCRIPTION OF THE DRAWINGS

FIG. 1 is a diagram showing one exemplary configuration of a structuralized document according to an embodiment of the present invention;

FIG. 2 is a diagram showing another exemplary configuration of a structuralized document according to an embodiment of the present invention;

FIG. 3 is a flowchart illustrating a process flow for archiving information;

FIG. 4 is a diagram illustrating an exemplary configuration of a contents delivery system according to an embodiment of the present invention;

FIG. 5 is a flowchart illustrating a process flow for activating the structuralized document;

FIG. 6 is a diagram illustrating process steps for acquiring contents to be input to the structuralized document;

FIG. 7 is a flowchart illustrating a process flow for acquiring a file from a designated folder;

FIGS. 8A-8D are diagrams illustrating an exemplary process of inputting contents to the structuralized document using a search service;

FIGS. 9A and 9B are flowcharts illustrating other exemplary process flows for inputting contents to the structuralized document;

FIG. 10 is a diagram illustrating a basic process flow for establishing synchronization when contents are acquired;

FIG. 11 is a table illustrating exemplary log information that may be recorded in the structuralized document;

FIG. 12 is a flowchart illustrating a process flow for inputting contents into the structuralized document in a case where the document does not include a corresponding program for the extension of the contents to be input;

FIG. 13 is a diagram illustrating processes for accessing a program providing server;

FIG. 14 is a diagram illustrating process steps for contents delivery;

FIG. 15 is a diagram illustrating process steps involving charging a fee for contents delivery; and

FIG. 16 is a diagram illustrating process steps for preventing unauthorized copying.

### DESCRIPTION OF THE PREFERRED EMBODIMENTS

In the following, preferred embodiments of the present invention are described with reference to the accompanying drawings.

[Structure of Information Accumulating Document]

In the following, an example using a Jar (Java Archive) file to construct an information accumulating document (encapsulated document) is described. The Jar file is an archive file based on the widely used ZIP file format, and is a representative example of a platform-independent file format that compiles plural files into one file. The structure of such an encapsulated document and the method for generating such a document are described below.

[Structure of Encapsulated Document]

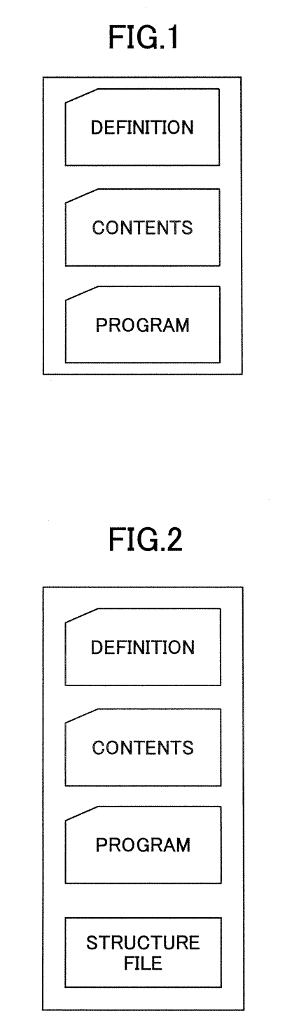

FIG. 1 is a diagram showing the structure of an encapsulated document (Jar file). The encapsulated document includes a definition folder (corresponding to “META-INF” folder of Jar file) in which a main program definition file (manifest file) is stored where program information to be initially loaded upon activation is described.

The encapsulated document may also include a contents folder in which test files and image/audio files may be stored. It is noted that the contents may not exist initially in some cases. Thus, the contents folder does not necessarily have to be provided. However, the illustrated example includes the contents folder to distinguish it from other file groups (e.g., program files). Also, it is noted that plural contents folders may be included in the encapsulated document.

The encapsulated document also includes a program folder storing a group of program files. Also, in one preferred embodiment, a structure file may be included in the encapsulated document as is shown in FIG. 2 to facilitate management of contents and programs stored in the encapsulated document. The structure file is configured to manage programs and contents within the encapsulated document (Jar file), and may be described using XML (extensible Markup Language) as is shown below, for example.

<?xml version=“1.0” encoding=“utf-8”?>
<encapsulateddoc>

<programs>

<prog1/>
<prog2/>
<prog3/>

</programs>
<contents>

<page1>

<index.html/>

</page1>

</contents>

</encapsulateddoc>

By having the above XML information described in the structure file, for example, the order in which programs are loaded may be designated as prog1→prog2→prog3, and the first page of the contents may be designated to be an index.html page, for example. An information accumulating document (encapsulated document) that accumulates information by acquiring external resources may store programs for acquiring external resources in its program folder and describe the names of the programs in its structure file. In the following, the method of generating such an information accumulating document is described.

[Information Accumulating Document Generating Method]

It is noted that the encapsulated document (Jar file) itself may be an archive file similar to a ZIP file. That is, a document structure as is shown in FIG. 2 may be packaged as one file. An exemplary description of a main program definition file required for the encapsulated document file is shown below.
Manifest-Version: 1.0
Main Class: Appmain
Created-By: 1.3.1 (Ricoh Company, LTD.)

In the above exemplary description, the second line describes the program file name of the program containing a main function. By specifying this program, the program file to be initially loaded upon activation may be determined. The third line describes the program version (e.g., a Java version number is described in the illustrated example) and the supplier.

The main program definition file as is described above is integrated with contents and a program file group including an external resource acquiring program to form an archive file.

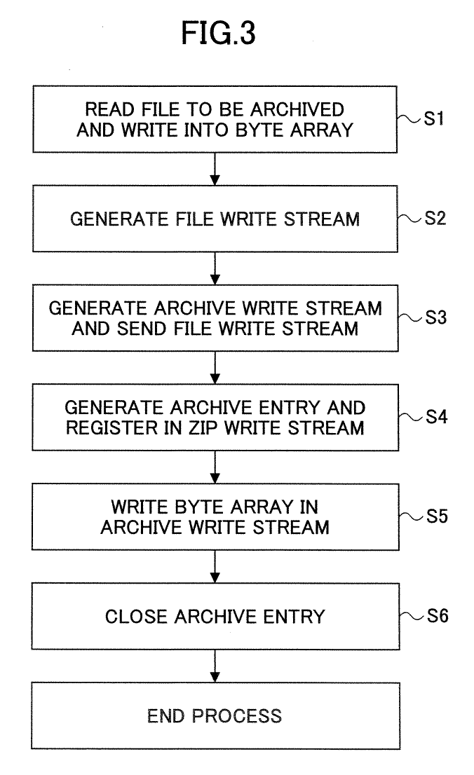

FIG. 3 is a flowchart illustrating archiving processes that are performed in the above example.

According to FIG. 3, a file to be archived is read and written into a byte array in step S1. Then, a file write stream is generated in step S2, and an archive write stream is generated and the file write stream is transmitted in step S3. Then, an archive entry is generated to be registered in a ZIP write stream in step S4, and the byte array is written in the archive write stream in step S5. Then, the archive entry is closed in step S6, and the process is ended.

It is noted that the above-described process is a basic process flow for archiving one file. However, the process may be similarly performed with respect to plural files, for example. In this way, a manifest file, contents, and a program group including an external resource acquiring program may be handled as one archive file.

Also, in the case of generating a Jar file, if the Java SDK (Software Development Kit) is installed, the Jar file may be easily generated by simply inputting a command such as [jarcvfmsample.jarmanifest.mf*.*], for example. In terms of Java programming, the Jar file may be created by describing [jar cvfm sample.jar manifest.mf*.*] as a Runtime external program calling character string, for example.

[Encapsulated Document including External Resource Acquiring Program and External Resources]

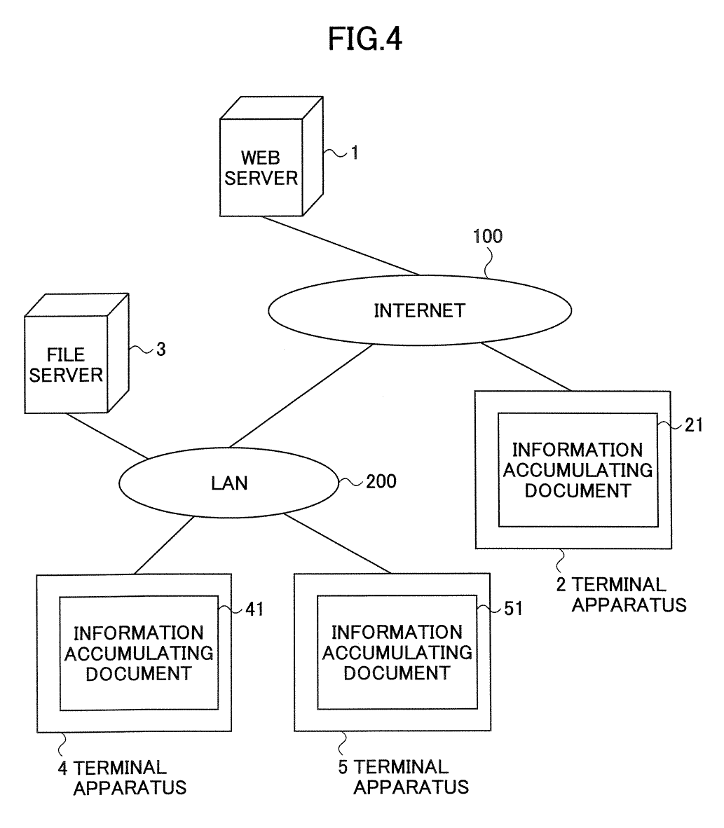

FIG. 4 is a diagram showing an exemplary configuration of a contents delivery system according to an embodiment of the present invention. Specifically, FIG. 4 illustrates connections between external resources, contents delivery server apparatuses, and encapsulated documents with an external resource acquiring program.

In the illustrated embodiment of FIG. 4, a web server 1 and a terminal apparatus 2 including an information accumulating document 21 are connected to the Internet 100. Also, a file server 3 and terminal apparatuses 4 and 5 including information accumulating documents 41 and 51, respectively, are connected to a LAN 200, which is connected to the Internet 100.

According to the present embodiment, a program file (external resource acquiring program) within a document may incorporate information into a document file by accessing the web server (website) 1 provided over the Internet 100 to acquire information and acquiring a file from the file server 3 provided over the LAN 200, for example. In this case, the information accumulating documents 21, 41, and 51 may be activated within their corresponding terminal apparatuses 2, 4, and 5 like normal documents to acquire external resources. Also, contents synchronization may be performed between documents exchanging contents, for example.

[Activation of Information Accumulating Document having External Resource Acquiring Function]

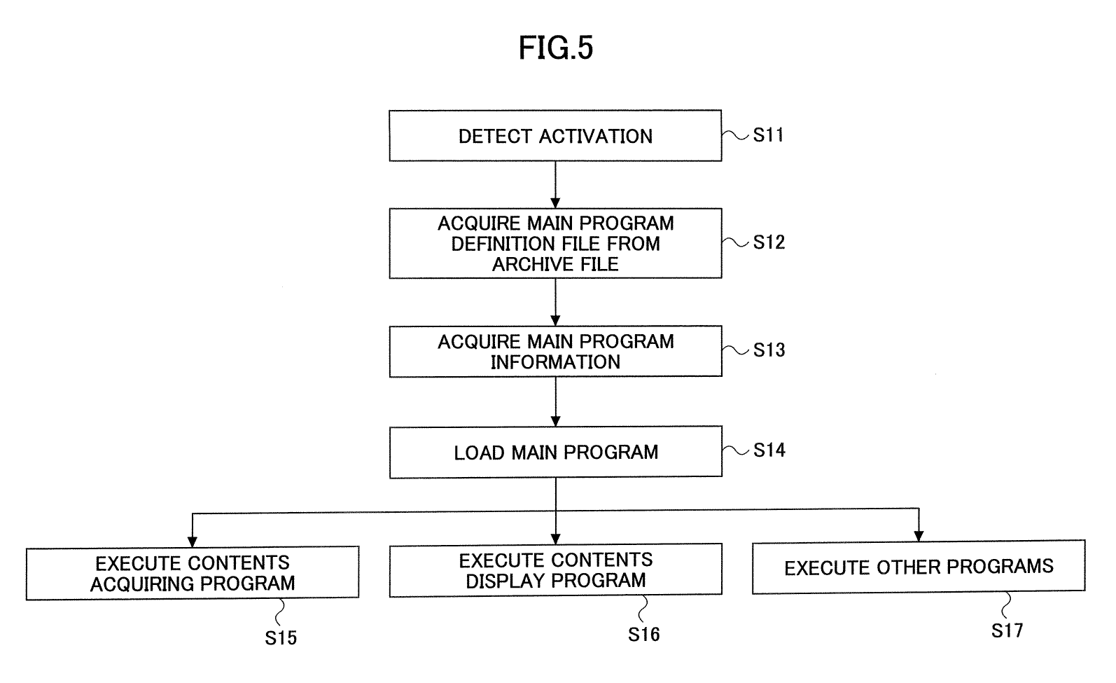

FIG. 5 is a flowchart illustrating the process flow for activating a document having an external resource acquiring function. According to FIG. 5, when activation is detected in step S11, a main program definition file is acquired in step S12, and main program information is acquired in step S13 so that the main program may be loaded in step S14. The main program generally functions as a main routine, and in this way, commands are issued for executing various program files required for performing steps S15 through S17 of FIG. 5.

In this case, the document may include the following information.
Structure file: manages contents and programs within document file such as the loading order of the programs and the display order of contents;
Main program definition file (manifest file): describes name of program (class file) to be initially loaded upon activating document;
Contents (may not initially exist): contents such as text files, still image files, moving image files, audio files, and other files to be loaded or displayed according to programs;
Programs (class files): programs for loading or displaying documents (e.g., text and images) included in contents folder (e.g., required programs to be stored at the time of document generation for acquiring and displaying contents (external resources) expected to be archived; and programs for adding supplementary functions to the document such as communication functions including document display synchronization functions, add write functions, and recording functions including operation recording functions)

[Operations]

According to a double-click command or a command from a command line issued in step S11, the program file described in the main program definition file of the information accumulating document 21/41/51 is loaded to the terminal apparatus 2/4/5 in step S14. This program functions as a main routine and issues commands to execute various program files, or read/interpret the structure file to load/execute programs accordingly, for example.

Then, the loaded program file is executed, and in step S15, the contents acquiring program corresponding to one of such program files is loaded and executed. In step S16, contents such as text and images included in the contents folder (if such contents exist in the contents folder) are displayed by a display program. In step S17, programs for performing various functions are loaded. In this way, preparations for using and processing the information accumulating document 21/41/51 may be made. In the following, operations for acquiring contents and displaying the contents using the activated document are described.

[Contents Acquisition using Information Accumulating Document]

A simple example is described below in which the information accumulating document 21/41/51 accesses the web server 2, acquires information from the web server 2, and displays the acquired information. In this case, required programs, that is, programs to be initially stored in the document include a program for accessing a web server to acquire contents such as HTML contents, and a program for displaying contents such as HTML contents. It is noted that a web server that is accessed in the present example may be a server connected to the Internet. Also, it is assumed in the present example that the web server to be accessed is specified beforehand in the program for accessing the web server; however, embodiments of the present invention are not limited to this example, and arrangements may be made to have the user designate the web server to be accessed in other alternative examples.

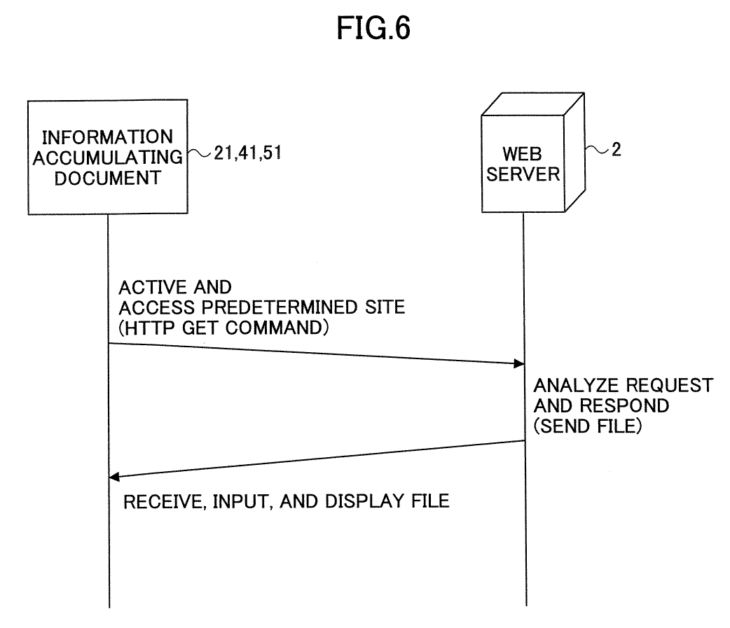

FIG. 6 is a diagram illustrating the process of acquiring contents for the information accumulating document 21/41/51. According to this example, when the information accumulating document 21/41/51 is activated in response to a double click command, the contents acquiring program is loaded and executed to transmit an HTTP GET command to the predetermined web server 2.

For example, when (http://webserver/index.html) is to be acquired, the contents acquiring program uses a socket to establish connection with the web server 2 and transmits a command such as “GET/index.html HTTP/1.0[CR LF(indent)]” to the web server 2 (the code at the end of the line is an indent code). It is noted that additional information is attached after the GET command although descriptions pertaining to such information are not given.

At the end of the GET command, a nil line (i.e., line that does not include any characters other than an indent code) is attached to the command in order to inform the web server 2 that the end of the command has been reached. It is noted that in a case where the terminal apparatus 2/4/5 is configured to access the web server 2 via a proxy server, the GET command may be expressed as follows to enable the proxy server to access the web server 2:
GET http://webserver/index.html HTTP/1.0[CR LF(indent)]

When the web server 2 receives the GET command, the web server 2 transmits the requested file to the information accumulating document 21/41/51. The information accumulating document 21/41/51 receives the transmitted file (index.html), and inputs and displays the received file. In this case, the display program included in the information accumulating document 21/41/51 is configured to be capable of analyzing and rendering HTML.

In one embodiment, the above-described sequence of operations may be programmed to be periodically performed so that information on a page of a certain site may be periodically acquired. Also, it is noted that in the above described example, only one site (i.e., web server 2) is accessed; however, in other embodiments, plural sites may be accessed and data distributed over the Internet 100 may be compiled and comprehensively managed.

[Storing Process after Contents Input]

In order to input contents to a document, the document file itself has to be recreated. Specifically, when an external file is input, contents are rearranged within the contents folder of the document file shown in FIG. 2 to recreate the archive file. It is noted that in some cases, the name of the acquired contents may be the same as the name of previously acquired contents stored in the contents file, for example. Accordingly, appropriate measures have to be taken such as generating the contents folder according to the acquisition time of contents, or reassigning the file names of contents, for example. Also, in recreating an archive file, the following points have to be taken into consideration.

First, it is noted that an archive file includes a header file that describes information such as the file names and sizes of the files being archived. An error occurs unless conformity is established between this header file and the actual files being archived. Accordingly, the archive file has to be recreated in a manner similar to the process of generating the information accumulating document so that the header file may be in conformity with the files being stored. Also, in a case where a structure file is used to manage contents and programs, the structure file has to be rewritten as well.

It is noted that in a case where new contents are added, the following contents tag may be added to the exemplary XML structure file described above, for example.

<page2>

<newpage.html/>

</page2>

In this way, the structure file may be updated in the archiving process.

[Acquisition of Specific File]

It is noted that the above example describes a case of simply acquiring HTML contents. In other examples, arrangements may be made to acquire a specific type of file. For example, an image file may be acquired by checking the source of the HTML and acquiring contents including an IMG tag, which may be described as:
<IMG SRC=“/images/sampl.jpg” HEIGHT=“100” WIDTH=“100”>

It is noted that other specific format files such as moving image files or MP3 files may be acquired in a similar manner.

Also, it is noted that file specification information may be described in an anchor tag or a reference attribute as a link such as <A HREF=“sample.jpg”> so that the corresponding file may be acquired from the referencing destination. In either case, the type of file may be determined by the extension attached to the contents information.

[Referencing Specific Folder]

In the following, referencing of a specific folder such as a file server or a shared folder provided over a LAN is described. For example, in the case of storing image data acquired by a scanner or a digital camera in a personal computer (PC), the data are generally stored in a predetermined folder. Accordingly, by designating the predetermined folder in which such data are stored and monitoring this folder, new contents may be input to the information accumulating document when new contents are added to the folder.

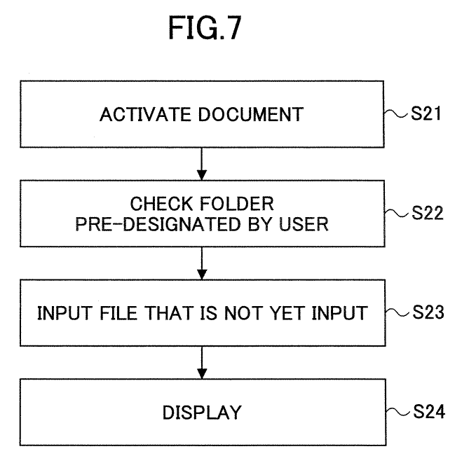

In this case, a user may be prompted to designate the predetermined folder. FIG. 7 is a flowchart illustrating the process of referencing a specific file. As is shown in this drawing, when the document is activated in step S21, a folder that is designated by the user beforehand is checked in step S22. If a file that has not yet been input to the document is stored in the folder, such a file is input to the document in step S23. In turn, the input file may be displayed in step S24. In this way, information in a shared folder on a LAN or a folder of a PC rather than a web server may be accessed to acquire information, for example.

It is noted that the above example describes a case of archiving contents of one folder; however other examples are possible in which information of plural folders distributed over a LAN are archived in one folder.

[Use of RSS]

As is described above, information may be periodically acquired from a web server according to one embodiment. However, there may be cases in which information has not been updated since the last time access has been made to the relevant site, and it may be preferred that information be acquired only when the site is updated and/or only the updated portion of information be acquired, for example. In such cases, the RSS (RDF Site Summary or Rich Site Summary) may be used. The RSS is an XML format that describes an overview of a web site as metadata.

Presently, there is a growing trend toward providing new information using RSS on a web site. For example, many blogs employ such functions. It is noted that a so-called RSS reader may be used to register the RSS of certain sites and blogs and acquire a list of articles posted on the registered sites and blogs. The RSS may be an XML file as is indicated below, for example, and updated information may be acquired by analyzing such a file.

[Example of RSS]

```
<?xml version=“1.0” encoding=“utf-8”?>
<rdf:RDF
  xmlns=“http://purl.org/rss/1.0/”
xmlns:rdf=“http://www.w3.org/1999/02/22-rdf-s
yntax-ns#” xml:lang=“ja”>
  <channel rdf:about=“http://machine.ricoh.co.jp/rss.rdf”>
```

<title>Ricoh Camer</title>
<link>http://machine.ricoh,co.jp</link>
<description>Provides information on cameras manufactured by

Ricoh</description>

<dc:date>2005-09-06T14:21:08+09:00</dc:date>
<items>

```
<rdf:Seq>
  <rdf:lirdf:resource=“http://machine.ricoh.co.jp/camera/”/>
  <rdf:lirdf:resource=“http://machine.ricoh.co.jp/docs/manual
```

.html”/>

</rdf:Seq>

</items>
</channel>

</rdf:RDF>

By using the RSS, analysis results of a file may be input to a document, or only relevant contents may be may be input, for example. In the above exemplary RSS, the element “title” includes the contents “Ricoh Camera”, and the element “description” includes the contents “Provides information on cameras manufactured by Ricoh”. Thus, basically, information may be acquired by referring the element name and its corresponding contents. Also, by referring to the value of the “rdf:resource” attribute, the page being viewed may be acquired (e.g., the page “http://machine.ricoh.co.jp/docs/manual.html” may be acquired in the illustrated example).

[Use of External Service]

In the following, operations are described for inputting the results of using a particular service on the web as opposed to simply acquiring information provided on the web. As one specific example, use of the Google API is described below. Google API enables use of a search service via a program. Specifically, the Google search service may be used by programming the process described below. (It is noted that the proxy relation has to be set in a case where proxy is used)

| | |
|---|---|
| Google Search s = new GoogleSearch( ); | //instance |
| generation for search | |

| | |
|---|---|
| s.setProxyHost(“proxy server name”); | //proxy server set |

| | |
|---|---|
| s.setProxyPort(port Number); | //port number |

set

| | |
|---|---|
| s.setProxyUserName(“name”); | //proxy user name |

set

| | |
|---|---|
| s.setProxyPassword(“password”); | //proxy |

| password set | |
|---|---|
| s.setQueryString(“search word”) | //search word |
| set | |
| GoogleSearchResult r = s.doSearch( ); | //search, |
| search result acquisition | |

In this process, candidates of desired information are simply acquired. Thus, a user may wish to sequentially view the candidates to determine and input the information he/she desires. It is noted that an internal program may be used to sequentially view the candidates. When desired contents to be input are found, the displayed page with the relevant contents may be input. In one example, arrangements may be made for the option “input” to appear in the right click menu being displayed. In the following, operations performed in the case of using such a search service are described.

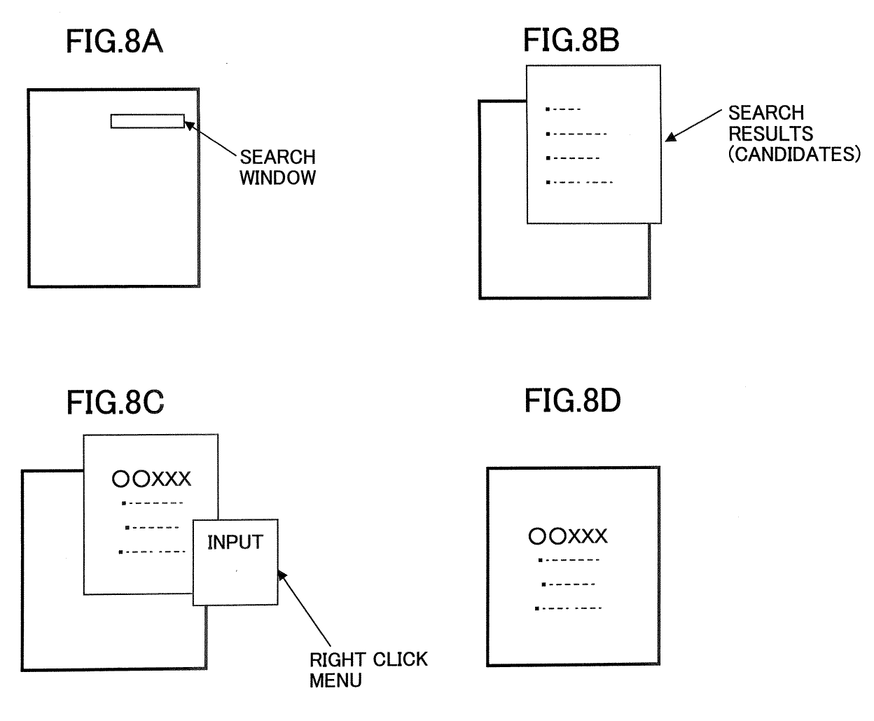

FIGS. 8A-8D are diagrams illustrating an exemplary process of inputting contents to a document using a search service via a search service program as is described above. It is noted that the search service may be provided as one of the programs included in the document. In the present example, a user may input a character string into a search window of a document as is shown in FIG. 8A and press a return key, for example, so that the search service program may detect the action of the user, acquire the character string input by the user, and make inquiries to the search service by performing the program processes as is described above.

The search results from the above search process may be displayed as a list on a separate window that is independent from the document as is shown in FIG. 8B, and a user may display information from the list on the window and search for desired information. The window may acquire mouse operation events of the user to display a menu as is shown in FIG. 8C, for example. When the user selects the option “input” included in the displayed menu, the contents displayed on the window may be incorporated into the document as is shown in FIG. 8D.

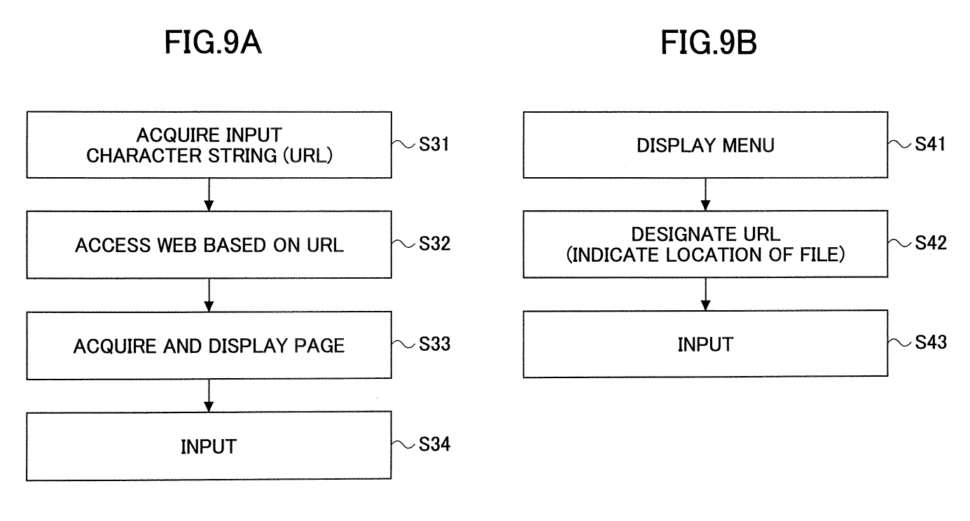

It is noted that the above-described example is related to a case of using a search service. However, in another example, a window may be provided for simply having a user input a URL so that information of a web site may be input to a document. FIG. 9A is a flowchart illustrating process steps performed in such an example. Specifically, when a character string (URL) is input by a user in step S31, a web site may be accessed based on the input URL in step S32. Then, a relevant page may be acquired and displayed in step S33, and the acquired page may be input to the document in step S34.

In another example, an image or MP3 rather than a web page may be input to a document as is described above. FIG. 9B is a flowchart illustrating exemplary process steps for performing such operations. Specifically, when a right clicking operation is performed on text information included in a document, a menu may be displayed in step S41, a URL may be specified (i.e., the location of a file may be specified) in step S42, and the specified URL may be described in the text information as a link to an image file or some other type of file, for example.

In another example, an image or text as a part of contents of a page being displayed at a browser may be input to a document through copying and pasting. In this case, information may be input to a clipboard through copying, and the information may be input to the document by pasting. If the acquired information is the so-called link information that starts with “http://”, the URL may be accessed, and the corresponding page may be acquired, displayed, and input to the document as is described above.

In another example, desired information may be dragged and dropped to input the desired information to a document. In this case, the process steps involved are substantially identical to the process steps performed for copying and pasting desired information. However, it is noted that the document has to include a program for acquiring a drop event and acquiring information on the acquired event.

[Synchronization with Other Document: Synchronization of Acquired Information]

According to one preferred embodiment of the present invention, a technique is provided for synchronizing document display including addition of contents while establishing communication. As can be appreciated from the above descriptions, advantages with respect to communication may be obtained by synchronizing information input between plural documents. Specifically, in a case where plural documents are activated and the display of the documents is synchronized through communication, when contents are added to one document, the acquired contents is preferably provided to the other document in order to maintain smooth communication.

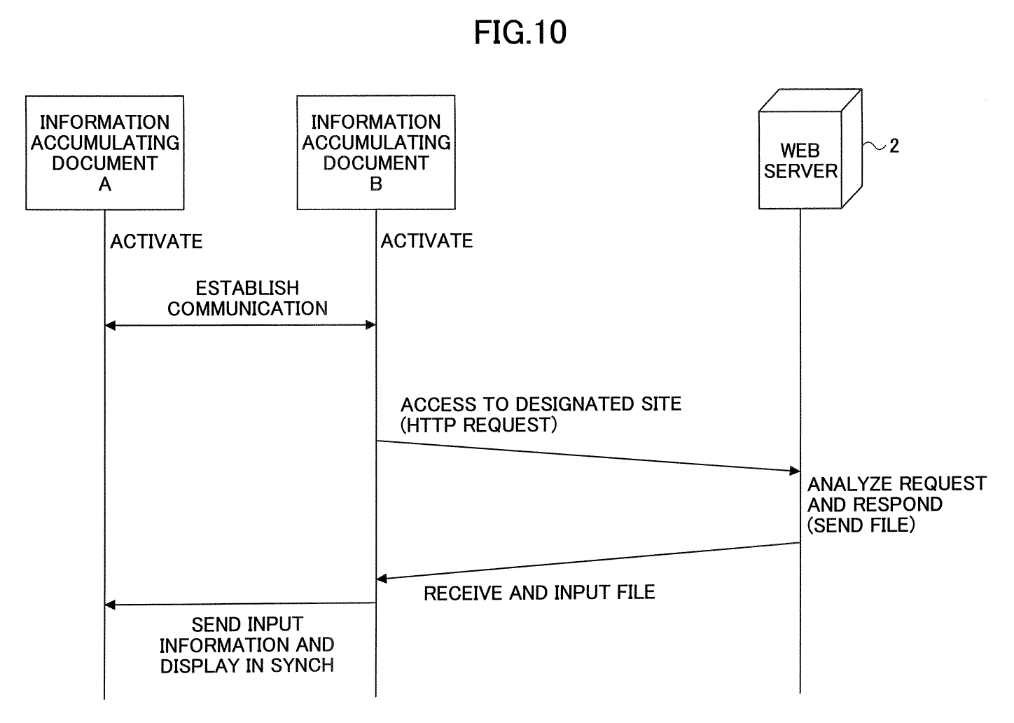

FIG. 10 is a diagram illustrating a basic process flow for establishing synchronization when contents are acquired. In the illustrated example, information accumulating documents A and B (e.g., corresponding to the information accumulating documents 21, 41, or 51) are activated and communication is established between these documents. It is noted that in the present example, communication refers to a state in which information accumulating documents exchange document IDs and activated IP addresses with each other so that each document may recognize the address at which its counterpart document is operating on a network.

In this case, when page 2 is displayed on document A, for example, the same page 2 may be displayed on document B, which is in communication with document A. As is illustrated in FIG. 10, when document B accesses the web server 2 through any one of the methods described above in response to user operations, for example, and acquires and inputs the contents, document B transmits a copy of the input contents to document A with which it is currently establishing communication. In turn, document A receives the copy of the input contents transmitted from document B, and inputs and displays the received contents.

By performing the processes as is described above, document synchronization may be established between documents that are in communication with each other and uniformity of contents contained in the documents may be maintained. It is noted that it may be difficult to input additional contents while the document is being displayed. Accordingly, in one embodiment, the additional contents to be input may be stored in a temporary folder, and only the display may be synchronized with contents input operations. In this case, the additional contents may be input to the document when the document is closed, or the document may be restarted to actually input the additional contents, for example.

[Non-activated Document]

It is noted that contents uniformity between documents programmed to be in synchronization may not be maintained when one of the documents is not activated. For example, in the illustrated example of FIG. 10, such a problem may occur in a case where document A that is supposed to be in communication with document B is already closed when document B acquires new contents, or document B adds new contents when only document B is activated even though documents A and B are programmed to be in synchronization.

In view of such circumstances, in a preferred embodiment, when documents are activated and communication is established between the documents, information exchange may be performed between the documents pertaining to the contents held in these documents to check for surplus/deficiencies in the contents of the documents. In this respect, log information of erasures and additions of information may be recorded in a document so that surplus/deficiencies in a document may be easily detected. When a document is determined to have deficiencies, the relevant contents may be requested from a counterpart document, and when a document is determined to have surplus contents, such contents may be erased. In the case of erasing contents, corresponding elements of the structure file of the document may be erased, the contents themselves may be erased, and the document may be re-zipped, for example. It is noted, however, that the contents do not necessarily have to be erased.

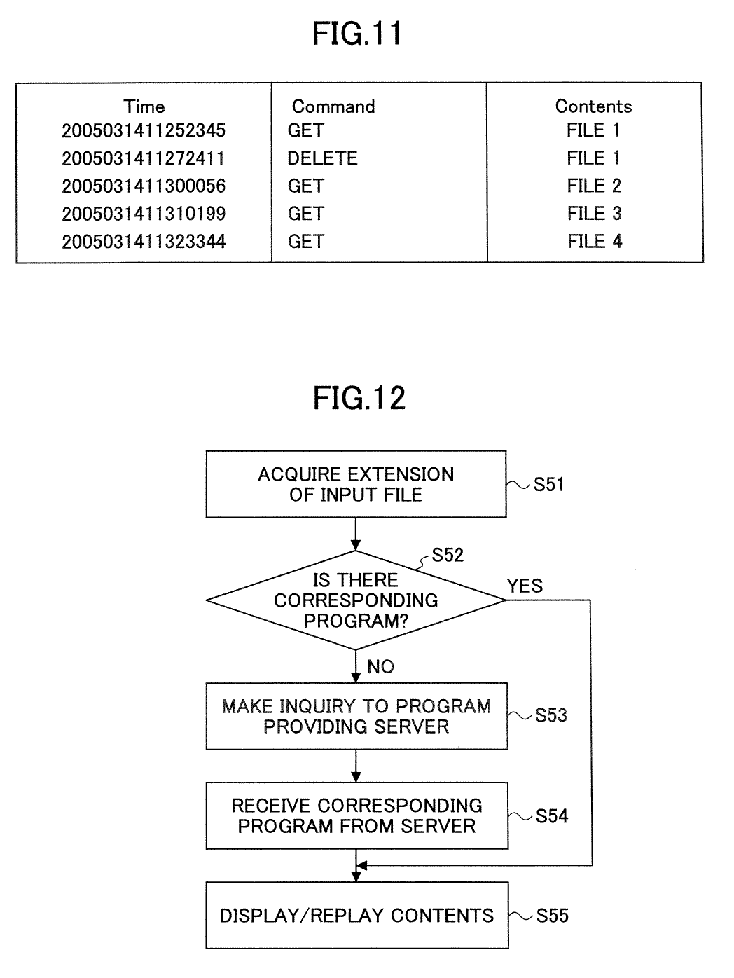

FIG. 11 is a table illustrating exemplary log information that may be recorded in a document. In this example, the time at which contents were acquired/deleted and the contents name are recorded. By referring to such log information, the above-described process of determining surplus/deficiencies of a document may be performed, and the contents currently stored in the document may be determined. For example, it may be determined from the log information of FIG. 11 that FILE 2, FILE3, and FILE 4 are currently stored in the document.

[Conflicting Events]

For example, there may be a case where documents A and B input different contents virtually simultaneously. In this case, at the time the contents are input, the documents A and B have different contents stored therein, and when synchronization between the documents A and B is performed, there may be a problem in determining the order of the contents. In this respect, according to one embodiment, the time at which the contents were input may be recorded so that the contents input earlier may come before the contents input later.

It is noted that in one embodiment, time information managed at one terminal apparatus may not necessarily be consistent with time information managed at another terminal apparatus so that it may not be possible to determine which contents were actually input earlier. However, since the above measure is taken in order to avoid discordance between the documents, the actual time order of the input events may not be a matter of concern. Also, in a case where the time of the input events is exactly the same, it may be determined beforehand which contents are to come first. In another embodiment, if the terminal apparatuses holding the documents have access to a time server, time information may be obtained from the time server. Another issue to be addressed is that the contents name of the contents input to documents A and B may be identical, for example. In such a case, the contents name may have to be reassigned, for example.

[Archiving Mail]

In the following, the archiving of specific mail is described. For example, mail transmittals of a specific mail magazine may be accumulated into one document so that the mail magazine may be compiled into one file. According to an embodiment, a program for accessing a mail server and acquiring copies of mail related to a predetermined subject may be incorporated into a document instead of the program for acquiring contents from a web server or a folder as is described above.

In one embodiment, the predetermined subject may be designated by a user beforehand. It is noted that the subject of a mail magazine is generally fixed, and is basically described by “title+volume number+date”. In this respect, a title may be designated by the user, for example. Also, the user may be required to perform regular mailer setup operations (e.g., setup for accessing a POP server or IMAP server).

In one embodiment, the program for acquiring predetermined mail incorporated in a document as is described above may be configured to periodically access a mail server based on information designated by a user. Upon accessing the mail server, the program may acquire a copy of mail containing a character string matching that designated by the user and input the acquired copy in the document. It is noted that the accessing, acquiring, and inputting processes of the present embodiment may be substantially similar to those described above. Also, it is noted that in order to periodically access the mail server, the information accumulating document has to be activated on a continuing basis. In another embodiment, instead of periodically accessing the mail server, access may be made to the mail server when the document is activated to collectively acquire and input new mail transmittals of the relevant mail magazine. However, in this case, the mailer being used has to be setup so that received messages remain in the server (in the case of a POP server).

[Operations of Server]

It is noted that in the above descriptions, the server is assumed to be a general web server or a mail server. In the following, operations and usage of a server such as an information accumulating document delivery server according to preferred embodiments of the present invention are described.

[Acquiring Program from Server]

In the above-described preferred embodiments, a program (class file) for accessing contents to be input to a document is incorporated in the document beforehand. However, there may be cases in which contents in a format that has not been considered at the time of document creation is acquired and input to the document. It is noted that contents may be associated with a corresponding program for accessing the contents by an extension in the contents file. For example, if the contents are in jpg, gif, or png format an image viewer may be required for accessing the contents; if the contents are in HTML format, an HTML viewer may be required to access the contents; if the contents are in MP3 format, a corresponding music replay program may be required to access the contents. Thus, a program to be used for accessing contents may be determined based on the file extension described in the contents.

FIG. 12 is a flowchart illustrating process steps for inputting contents into a document in a case where the document does not include a program corresponding to the extension of the contents to be input. According to FIG. 12, an extension of a file to be input is acquired in step S51, and a determination is made as to whether a corresponding program for the acquired extension is included in the document in step S52. In a case where such a program is not included (Step S52, No), an inquiry is made to a program providing server in step S53, and the corresponding program is acquired in step S54. Then, contents are displayed/replayed in step S55. It is noted that in a case where the corresponding program is included in the document (step S52, Yes), the process proceeds directly to step S55 where contents are displayed/replayed.

It is noted that in the above-described process, the program providing server may transmit the corresponding program to the document making the inquiry based on the extension information. In a case where the corresponding program is not available, a notification indicating such circumstance is sent to the document as a response to the inquiry. In turn, the document may display a message indicating, “no corresponding program has been found”, for example.

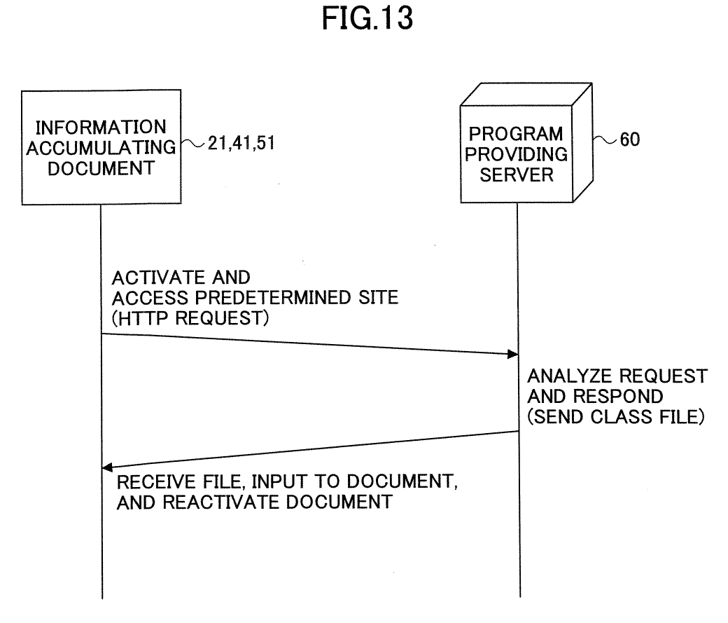

FIG. 13 is a diagram illustrating processes of the document and the program providing server. According to FIG. 13, when the information accumulating document 21/41/51 is activated by the double clicking operations by the user, for example, a program acquisition program is loaded and executed so that an HTTP GET command is transmitted to a predetermined program providing server 60. Upon receiving the HTT GET command, the program providing server 60 transmits the corresponding program being requested by the information accumulating document 21/41/51. In turn, the information accumulating document 21/41/51 receives the program transmitted from the program providing server 60 and inputs the received program after which it is reactivated.

[Information Accumulating Document Delivery Server]

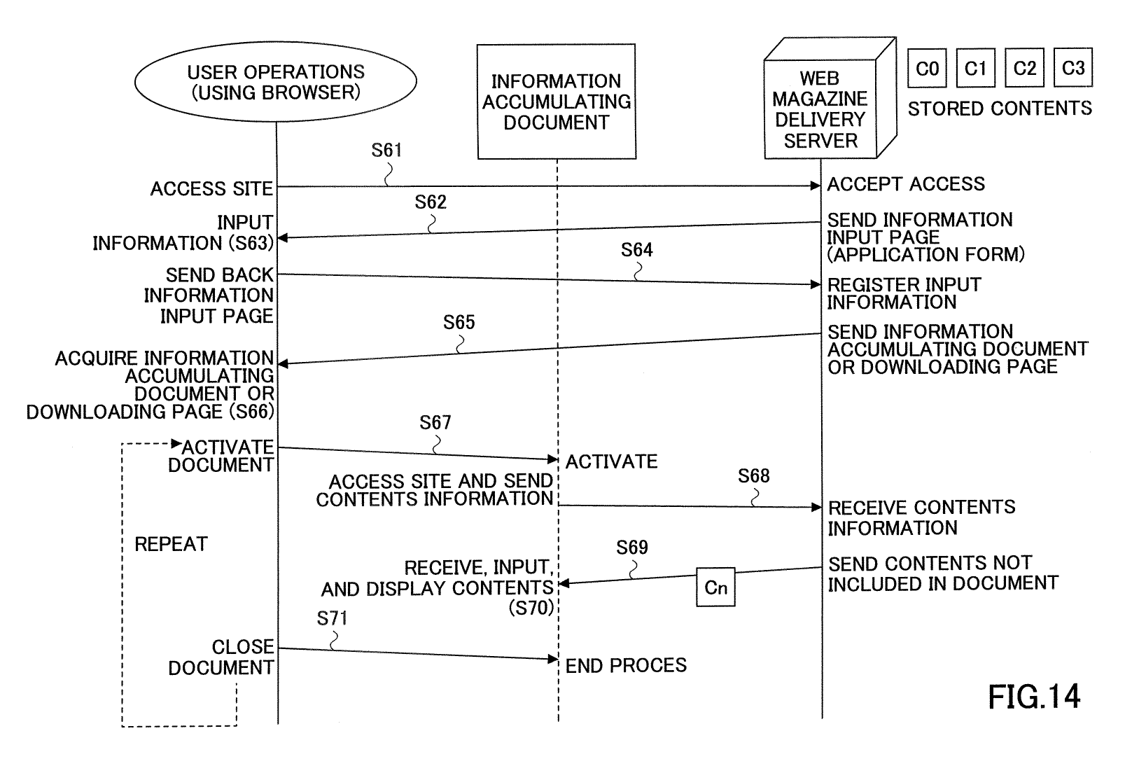

An information accumulating document delivery server is configured to create an information accumulating document on a server and deliver the created document to a terminal apparatus. In the following, a web magazine delivery server is described as one example of such an information accumulating document delivery server. FIG. 14 is a diagram illustrating operations of an information accumulating document (e.g., web magazine) and a web magazine delivery server in relation to user operations of a web browser. In the following, user operations and document/server operations are described in chronological order with reference to FIG. 14.

When a user accesses a site on the Internet using a web browser and request for web magazine delivery in step S61, the web magazine delivery server sends an application form to the web browser in step S62. In turn, the user may input required items of information to the application form displayed on the web browser in step S63. In this step, the user may input (or select) a title of desired information and an e-mail address, for example.

In turn, the web magazine server registers the information input by the user, sets a URL from which information associated with the input title of desired information may be acquired, generates an information accumulating document, and sends the generated document to the registered e-mail address of the user in step S65. Alternatively, the web magazine delivery server may send a document downloading page to the web browser. In turn, the user may acquire the document as an attached file of an e-mail message or by downloading in step S66. Then, the user may activate the received information accumulating document in step S67.

When the document is activated, a program incorporated in the document accesses the URL set by the web magazine delivery server in step S68. In this case, the document sends information on the contents it currently holds (contents information) to the web magazine delivery server. In turn, the web magazine delivery server refers to the contents information and sends contents that are not currently included in the document (if such contents exist at the server side) to the document in step S69. In turn, the document receives the contents, and inputs and displays the received contents in step S70. Then, the document may be closed through user operations in step S71. It is noted that steps S67 through S71 may be repeated to accumulate contents in the document.

In this way, an information delivery mechanism may be constructed that is different from conventional mechanisms used for delivering mail magazines. It is noted that in the illustrated example, the same server is used to provide the information accumulating document to the user, and deliver contents to the information accumulating document acquired by the user. However, the in other examples, separate servers may be accessed for acquiring the information accumulating document and acquiring contents to be accumulated. Also, in addition to accumulating contents, arrangements may be made so that contents stored in the document for over a predetermined time period are deleted, for example. It is noted that in a case where the document is operating on a LAN and Internet access has to be made via a proxy server, the user has to set information such as a port number, a user name, and a password to the proxy server beforehand. However, such setting procedures may be performed in a manner identical to the case of setting the web browser.

In the following, exemplary applications of the information accumulating document delivery server are described. In one example, a free web magazine may be accessed in synch by plural users at remote locations, and a file related to the contents of the web magazine may be added in synch. In another example, when a web magazine is used as some kind of educational material, plural users may communication with each other by accessing the web magazine and inputting relevant files to share additional information with other users.

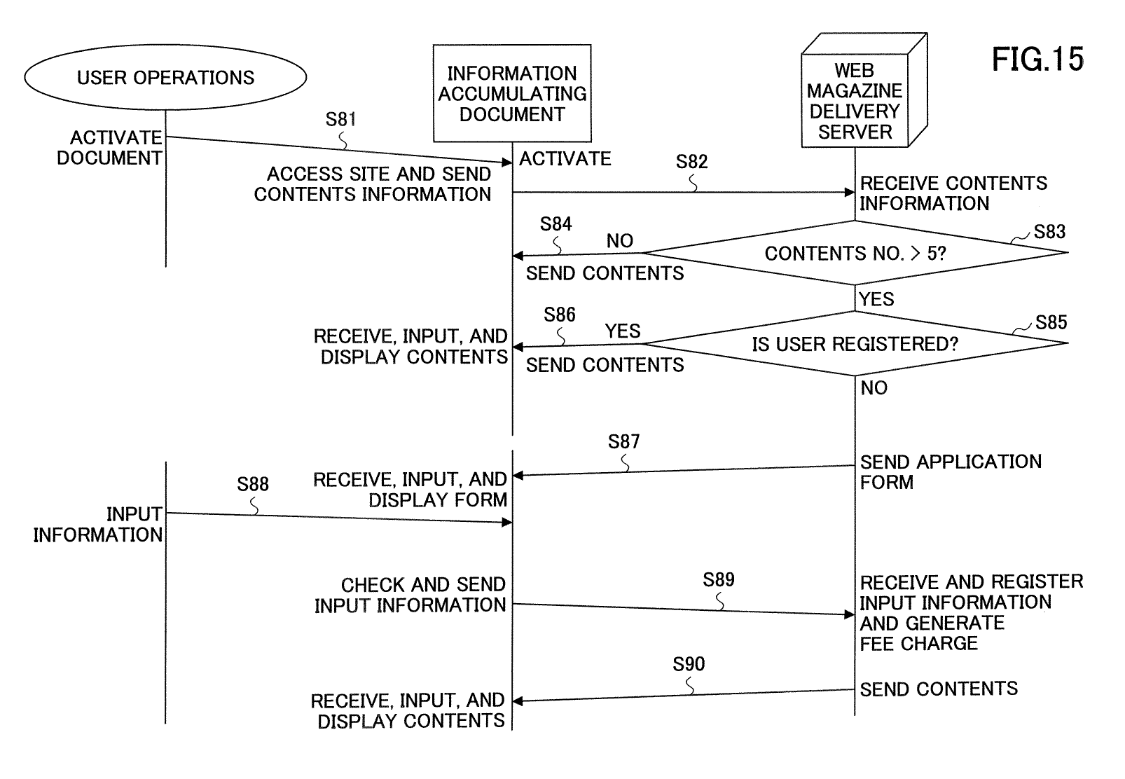

FIG. 15 is a diagram illustrating an exemplary process flow for fee charging. According to the illustrated example, when a document (information accumulating document) is activated in step S81, the document sends its contents information to a server (web magazine delivery server) in step S82. In turn, the server receives the contents information of the document and determines whether the contents not included in the document satisfies a predetermined condition (e.g., the contents number has to be less than or equal to 5 in the illustrated example) in step S83, and if the contents not may be sent to the document in step S84.

On the other hand, when the contents not included in the document is subject to fee charge (step S83, Yes), a determination is made as to whether the user of the document is a registered user in step S85. For example, the determination of whether the user is a registered user may be performed based on a registration ID that is sent by the user along with the contents information. When the user is confirmed to be a registered user (step S85, Yes), the server sends the contents not included in the document to the document in step S86.

In the case where the user is not a registered user (step S85, No), an application form is sent to the document in step S87. In turn, the document receives and displays the application form. The user inputs information to the application form in step S88, and the input information is sent to and registered in the server so that a fee may be charged in step S89. Then, the contents not included in the document are delivered from the server to the document in step S90. It is noted that in the illustrated example, a fee is charged only once at the time of registration. However, other examples are possible such as that where a fee is charged each time new contents are to be delivered.

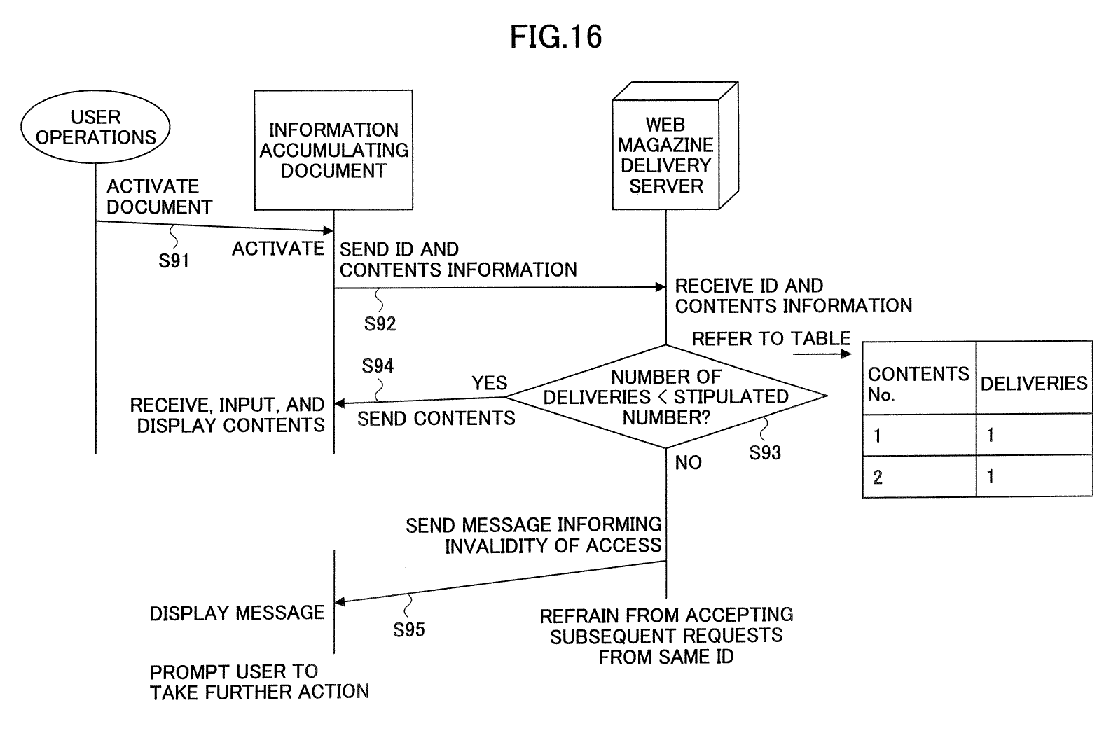

FIG. 16 is a diagram illustrating an exemplary process flow for preventing unauthorized copying. This example employs a scheme for limiting the number of times the same contents are acquired with the same ID. It is noted that when duplicate copies of a document are made, the duplicates basically have the same ID as the original so that plural documents with the same ID are created. Therefore, unauthorized copying may be detected when delivery of the same contents are requested plural times by the same ID, and preventive measures may be taken to limit such unauthorized copying.

According to the example of FIG. 16, when a document (information accumulating document) is activated in step S91, the document sends its ID information and contents information to a server (web magazine delivery server) in step S92. In turn, the server receives the information from the document, and refers to a table associated with the corresponding document ID indicating the relationship between the contents number identifying contents subject to delivery and the number of deliveries made to determine whether the number of times corresponding contents have been delivered to the document is below a stipulated number in step S93. If the number of times the corresponding contents have been delivered is below the stipulated number (step S93, Yes), the server sends the corresponding contents to the document in step S94. On the other hand, if the number of deliveries made has already reached the stipulated number, the server sends a message to the document indicating the invalidity of the access.

As can be appreciated from the above descriptions, a structuralized document according to an embodiment of the present invention includes at least a program part and a contents part, the program part including a program for accessing a contents delivery server apparatus, inputting contents provided at the contents delivery server apparatus as an external resource, restructuring the input external resource into a document file, and storing the document file in the contents part. According to an aspect of the present embodiment, external resources may be input to a document to archive information, and the archived information may be handled as one document. Thus, the structuralized document of the present embodiment may be used to compile information distributed over the web or a LAN, or to enable fixed point observation of web information, for example.

In one preferred embodiment, the external resource input to the structuralized document may be electronic mail contents or contents of a designated URL. According to an aspect of such an embodiment, a special program does not have to be activated for archiving contents as a document so that contents may be efficiently stored with improved portability to thereby facilitate handling.

In another preferred embodiment, the structuralized document may further include a program for generating a fee charge upon inputting an external resource so that the structuralized document may be suitably used for charged contents delivery, for example.

In another preferred embodiment, the structuralized document may further include a program for synchronizing the restructured document file restructured from the input external resource with an external document. According to one aspect of the present embodiment, when communication is established between plural parties using structuralized documents, for example, the incorporation of external information into one of the documents may be reflected at the other document so the quality of communication through the use of documents may be improved.

In another preferred embodiment, an identification code is attached to the program included in the program part of the structuralized document, and the number of times a given external resource is input from the contents delivery server apparatus is limited by the identification code so that unauthorized copying may be prevented, for example.

In another preferred embodiment, update information may be included in the external resource, and the function of inputting contents provided at the contents delivery server apparatus as an external resource may be executed only when it is determined based on the update information that the external resource has been updated. According to an aspect of the present embodiment, document versatility may be improved, and since the document does not necessarily have to be connected to the server once contents are acquired, communication costs (e.g., fees and traffic) may be reduced and acquired contents may be accessed even under an environment where connection cannot be established with the contents delivery server, for example.

A contents delivery server according to an embodiment of the present invention includes a storage part that stores a structuralized document having at least a function of inputting an external resource and a function of restructuring the input external resource into a document file and storing the restructured document file; a structuralized document transmitting part that transmits the stored structuralized document in response to access made by a terminal apparatus; and an external resource transmitting part that transmits contents prepared in response to access made by the terminal apparatus as the external resource. According to an aspect of the present embodiment, external resources may be input to a document to archive information, and the archived information may be handled as one document so that information distributed over the web or a LAN may be compiled and/or fixed point observation of web information may be enabled, for example.

A contents delivery system according to an embodiment of the present invention includes a contents delivery server apparatus that stores a structuralized document having at least a function of inputting an external resource and a function of restructuring the input external resource into a document file and storing the restructured document file; a terminal apparatus that is connected to the contents delivery server apparatus via an information network; a structuralized document transmitting part as part of the contents delivery server apparatus that transmits the stored structuralized document in response to access made by the terminal apparatus; and an external resource transmitting part that transmits the external source in response to access made by the terminal apparatus. It is noted that the external resource transmitting part may be provided either as a part of the contents delivery server apparatus or as a separate unit. According to an aspect of the present embodiment, external resources may be input to a document to archive information, and the archived information may be handled as one document so that information distributed over the web or a LAN may be compiled and/or fixed point observation of web information may be enabled, for example.

Although the present invention is shown and described with respect to certain preferred embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-316897 filed on Oct. 31, 2005, the entire contents of which are hereby incorporated by reference.

What is claimed is:

1. A structuralized document comprising:
a contents part that stores contents; and
a program part that stores a computer-readable program which, when executed by a computer, causes the computer to perform a process including the steps of accessing a contents delivery server apparatus, inputting contents provided at the contents delivery server apparatus as an external resource, restructuring the input external resource into a document file, and storing the restructured document file in the contents part.

2. The structuralized document as claimed in claim 1, wherein
the input external resource corresponds to at least one of electronic mail contents and contents of a designated Uniform Resource Locator.

3. The structuralized document as claimed in claim 1, wherein
the process further includes a step of generating a fee charge when the external resource is input.

4. The structuralized document as claimed in claim 1, wherein
the process further includes a step of synchronizing the restructured document file with an external document.

5. The structuralized document as claimed in claim 1, wherein
an identification code is assigned to the program stored in the program part, and a number of times the external resource is input is controlled by the identification code.

6. The structuralized document as claimed in claim 1, wherein
update information is included in the external resource, and the step of inputting the external resource is performed when the external resource is determined to be updated based on the update information.

7. A contents delivery server apparatus comprising:
a storage part that stores a structuralized document configured to input an external resource, restructure the input external resource into a document file, and store the restructured document file;
a structuralized document transmitting part that transmits the structuralized document in response to document access made by a terminal apparatus; and
an external resource transmitting part that transmits the external resource in response to contents access made by the terminal apparatus.

8. The contents delivery server apparatus as claimed in claim 7, wherein
the external resource corresponds to at least one of electronic mail contents and contents of a designated Uniform Resource Locator.

9. The contents delivery server apparatus as claimed in claim 7, further comprising:
a fee charge generating part that generates a fee charge to the terminal apparatus upon transmitting the external resource.

10. The contents delivery server apparatus as claimed in claim 7, wherein
the structuralized document is configured to synchronize the restructured document file with an external document.

11. The contents delivery server apparatus as claimed in claim 7, wherein
an identification code is assigned to the structuralized document transmitted to the terminal apparatus, and a number of times the external resource is input to the structuralized document is controlled by the identification code.

12. The contents delivery server apparatus as claimed in claim 7, wherein
the external resource includes update information.

13. A contents delivery system comprising:
a contents delivery server apparatus storing a structuralized document configured to input an external resource, restructure the input external resource into a document file, and store the restructured document file;
a terminal apparatus that is connected to the contents delivery apparatus via an information network;
a structuralized document transmitting part that is included in the contents delivery server apparatus, and is configured to transmit the stored structuralized document to the terminal apparatus in response to document access made by the terminal apparatus; and
an external resource transmitting part configured to transmit the external resource in response to contents access made by the terminal apparatus.

14. The contents delivery system as claimed in claim 13, wherein
the external resource corresponds to at least one of electronic mail contents and content of a designated Uniform Resource Locator.

15. The contents delivery system as claimed in claim 13, further comprising:
a fee charge generating part that generates a fee charge to the terminal apparatus when the external resource is transmitted from the contents delivery server apparatus to the terminal apparatus.

16. The contents delivery system as claimed in claim 13, wherein
the structuralized document is configured to synchronize the restructured document file with an external document.

17. The contents delivery system as claimed in claim 13, wherein
an identification code is assigned to the structuralized document that is transmitted to the terminal apparatus, and a number of times the external resource is input to the structuralized document is controlled by the identification code.

18. The contents delivery system as claimed in claim 13, wherein
the external resource includes update information, and the structuralized document is configured to determine whether the external resource is updated based on the update information and input the external resource when the external resource is determined to be updated.
